(19) United States
(12) Patent Application Publication
(10) Pub. No.: US 2002/0152878 A1
(43) Pub. Date: Oct. 24, 2002

(54) System for delivering music and apparatus for receiving music data

(76) Inventor: Teruo Akashi, Osaka-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/125,391

(22) Filed: Apr. 19, 2002

(30) Foreign Application Priority Data
Apr. 23, 2001 (JP) 2001-124342

(51) Int. Cl. G10H 1/26

(52) U.S. Cl. 84/609

(57) ABSTRACT

In the music data receiving apparatus, the music data receiver receives the music data broadcast by the broadcasting station, and then the reproducer reproduces the music data while the related information storage stores the related information for the music. The user, who is listening to the reproduced music, may give a download instruction, which orders to download the air, to the user's input receiver, if the user is pleased with the air. The download instruction is transmitted to the server accessor. The server accessor accesses the music delivery server, takes out the information for specifying the air to be downloaded from the related information storage, and then notifies it to the music delivery server. The music delivery server confirms the user or charges a fee executes, and then sends the specified air data.

This application is based on the application No. 2001-124342 filed in Japan, the contents of which are hereby incorporated by reference.

### BACKGROUND OF THE INVENTION

1. Field of the Invention

The present invention relates to a music delivery system for delivering digitized music data to users with charge, and to an apparatus for receiving the music data and an apparatus for adding air-related information to the music data, which are used for the music delivery system.

2. Description of the Prior Art

In recent years, music has been managed as digital data in accordance with development of the digital technique. Meanwhile, there has been ready such environment that the music can be delivered to the users through networks in addition to the conventional delivery form of music using package media, in accordance with development of the network technique.

The delivery of music data using the above-mentioned networks is executed by means of the following procedure. That is, a user accesses a server, which delivers the music data. Following that, in order to specify the music data, the user inputs a title or searches music data using information as to the singer's name or the like. Thus, if the user can confirm that the music data presented by the server coincides with the user's intent, the user may begin to download the music data.

In the conventional method described above, however, the user must have some information about the music in order to specify the music data. Therefore, in the conventional method, the following problem may exist. That is, even if the user desires to obtain the music data corresponding to the music reached the user's ears when the user is listening to the broadcast, the user cannot obtain the music data on that instance if the user does not have some knowledge about the music.

### SUMMARY OF THE INVENTION

The present invention has been developed to solve the conventional problem described above. It has an object to provide a means for delivering music, by which a user can easily download the music data corresponding to the music reached the user's ears even if the user does not have any knowledge about the music.

According to the present invention, music data previously contain air-related information to enable a user to specify the music. The air-related information can be automatically recognized using a receiving apparatus. Thus, the user can download the music data by communicating with a server for delivering the music data.

That is, according to a construction of the present invention, air-related information for specifying music is contained in music data which are broadcast by a broadcasting station. On the other hand, a music data receiving apparatus receives and reproduces the music data, while recognizing and storing the air-related information. The music data receiving apparatus accesses a music delivery server on the basis of the air-related information and then downloads the music data, in accordance with an instruction of the user. By virtue of the above-mentioned construction, the user can download the music which is being received from the music delivery server even if the user does not have any knowledge about the music.

Meanwhile, according to another construction of the present invention, there is provided a means which receives and reproduces the broadcast music data, and further sends the first air-related information received thereby as the second air-related information. Because the user can receive the second air-related information and specify the music which is being broadcast, the user can access the music delivery server utilizing the information so as to download the music data. According to the above-mentioned construction, as for music to which the user listens (or sees) through the receiving apparatus belonging to the user, the user can easily download the music reached the user's ears even if the user does not have any knowledge about the music.

More concretely, a system for delivering music according to the first aspect of the present invention is provided with a sending section for sending music data which include air data and air-related information for uniquely specifying the air data.

In the system for delivering music, instead of or in addition to the sending section, there may be provided a music delivery server for sending air data in accordance with a delivery demand including air-related information for uniquely specifying the air data. Hereupon, the sent air data is corresponding to the air-related information.

The system according to the first aspect of the present invention may further include (i) a music delivery server for sending air data in accordance with a delivery demand including air-related information for uniquely specifying the air data, (ii) a receiving section for receiving the music data, and (iii) an air data downloading section for sending the delivery demand including the air-related information received by the receiving section to the music delivery server while downloading the air data corresponding to the air-related information which is sent by the music delivery server. Hereupon, the system may be provided with a reproducing section for reproducing the air data received by the receiving section. In this case, the air data downloading section may send the delivery demand including the air-related information to the music delivery server in accordance with an instruction of a user who listens to the air data reproduced by the reproducing section, while downloading the air data corresponding to the air-related information which is sent by the music delivery server.

The system according to the first aspect of the present invention may further include a reproducing section for reproducing the air data received by the receiving section, and a music output section for outputting the air-related information in the music data received by the receiving section and all of or a part of the air data as occasion demands, to another apparatus. In this case, instead of the music output section, there may be provided an air data downloading section for downloading the air data corresponding to the air-related information using the air-related information, in accordance with an instruction of a user.

An apparatus for receiving music data according to the second aspect of the present invention is provided with (i) a receiving section for receiving the music data which include all of or a part of air data and air-related information for uniquely specifying the air data, (ii) a reproducing section for reproducing the air data received by the receiving section, and (iii) a downloading section for accessing a music delivery server using the air-related information to download the air data, in accordance with an instruction of the user. Hereupon, instead of the downloading section, there may be provided an output section for outputting the air-related information, or a part of desired ratio larger than or equal to 0 of the air data.

The apparatus for receiving music data according to the second aspect of the present invention may further include an output section for outputting the air-related information, or all of or a part of the air data.

An apparatus for receiving music data according to the third aspect of the present invention is provided with (i) a receiving section for receiving music data which include a part of desired ratio larger than or equal to 0 of air data and air-related information for uniquely specifying the air data, and (ii) a downloading section for accessing a music delivery server using the air-related information to download the air data, in accordance with an instruction of a user. Hereupon, instead of the downloading section, there may be provided an output section for outputting the air-related information, or a part of desired ratio larger than or equal to 0 of the air data.

An air-related information adding apparatus according to the fourth aspect of the present invention receives air data, and then adds air-related information for uniquely specifying the air data.

### BRIEF DESCRIPTION OF THE DRAWINGS

Various characteristics and advantages of the present invention will become clear from the following description taken in conjunction with the preferred embodiments with reference to the accompanying drawings throughout which like parts are designated by like reference numerals, in which:

FIG. 1 is a block diagram showing the construction of a system for delivering music according to Embodiment 1 of the present invention;

FIG. 2 is a view showing contents of music data which are broadcast by a broadcasting station in each embodiment of the present invention;

FIG. 3 is a block diagram showing the construction of another system for delivering music according to Embodiment 1 of the present invention;

FIG. 4 is a block diagram showing the construction of a system for delivering music according to Embodiment 2 of the present invention; and

FIG. 5 is a block diagram showing the construction of a system for delivering music according to Embodiment 3 of the present invention.

### DETAILED DESCRIPTION OF THE PREFERRED EMBODIMENTS

Hereinafter, some embodiments of the present invention will be described.

(Embodiment 1)

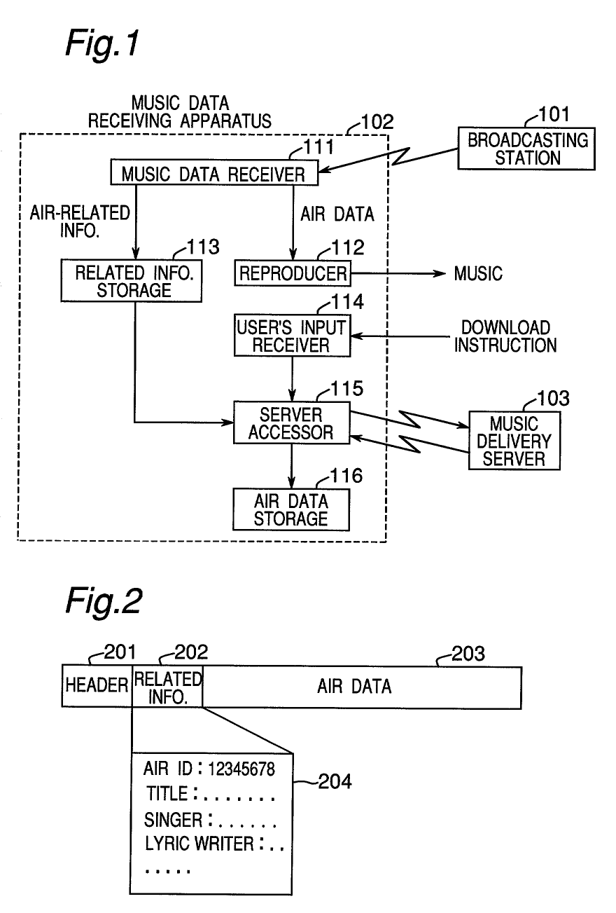

FIG. 1 shows the construction of a system for delivering music (or method of delivering music) according to Embodiment 1 of the present invention.

In FIG. 1, 101 denotes a broadcasting station which broadcasts music data including air information and air-related information. 102 denotes a music data receiving apparatus for receiving the music data. 103 denotes a music delivery server for delivering the music. The music data receiving apparatus 102 includes sections 111-116. 111 denotes a music data receiver (music data receiving section) which receives the music data broadcast by the broadcasting station 101. 112 denotes a reproducer (reproducing section) which takes out the air information from the music data and further reproduces the information as music.

113 denotes a related information storage (related information storing section) which takes out the air-related information from the music data and further stores the information. 114 denotes a user's input receiver (user's input receiving section) which receives a user's instruction ordering the receiver to download the air which is being reproduced. 115 denotes a server accessor (sever accessing section) which communicates the music delivery server 103 and further downloads the air specified by the air-related information stored in the related information storage 113, in accordance with the instruction ordering the download from the user's input receiver 114. 116 denotes an air data storage (air data storing section) which stores the air data downloaded by the server accessor 115.

FIG. 2 shows an example of a construction of the music data which are broadcast by the broadcasting station 101. As shown in FIG. 2, the music data is composed of a header 201, air-related information 202 and air data 203. The air-related information 202 includes an air ID for uniquely specifying the music by means of the music delivery server 103, and incidental information such as the title, singer or the like as to the air, as shown in a list 204.

Hereinafter, with reference to FIG. 1, each of the steps in the method of delivering music according to Embodiment 1 will be described. At first, in the music data receiving apparatus 102, the music data receiver 111 receives the music data which are broadcast by the broadcasting station 101, and then the reproducer 112 reproduces the music data while the related information storage 113 stores the related information for the music.

The user, who is listening to the reproduced music, may give a download instruction, which orders to download the air, to the user's input receiver 114, if the user is pleased with the air. This may be achieved by means of such an operation that the user pushes a push bottom provided in the music data receiver 102. The download instruction is transmitted to the server accessor 115. The server accessor 115 accesses the music delivery server 103, takes out the information for specifying the air to be downloaded from the related information storage 113, and then notifies it to the music delivery server 103. The music delivery server 103 confirms the user' status or charges a fee to the user, and then sends the specified air data. In Japanese Laid-Open Patent Publication No. 2000-90039 (entitled as “Method of delivering music, sending apparatus and method, and reproducing apparatus and method”), there is described in detail a method of delivering music, in which the protection of the copyright of the music data is considered when a communication is performed between the server accessor and the music delivery server. The server accessor 115 receives the air data and then making the air data storage store the air data. The stored air data can be reproduced by the reproducer 112 in accordance with the user's instruction.

As described above, according to Embodiment 1 of the present invention, the user can download and obtain the music by simply operating the music data receiving apparatus 102 even if the user does not have any knowledge about the music reached the user's ears.

Hereupon, the air data storage 116 may be composed of an internal memory of the apparatus or an external storage.

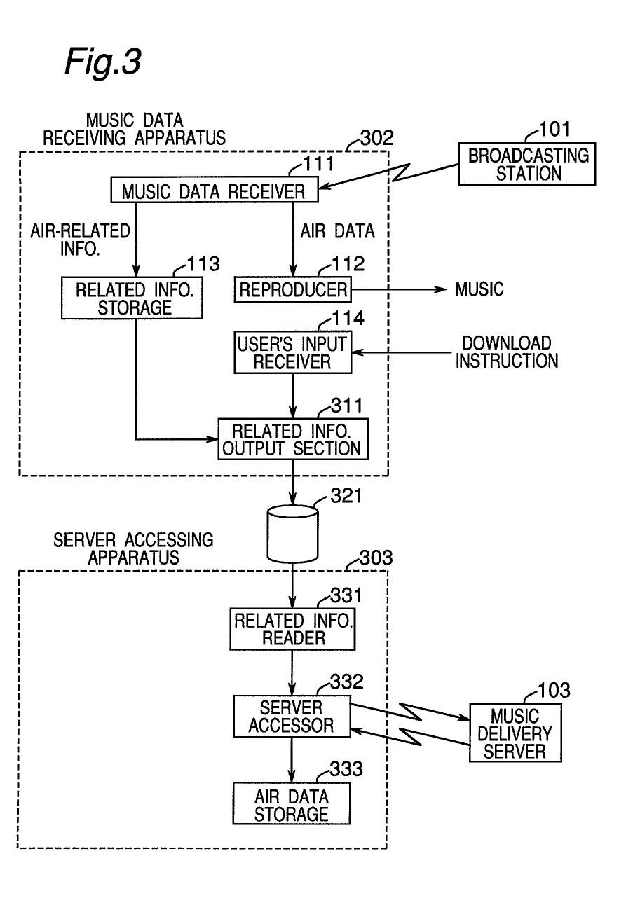

Alternatively, the step of accessing the music delivery server 103 may be executed using another apparatus. FIG. 3 shows the above-mentioned type of construction. As shown in FIG. 3, in this case, a related information output section 311 in the music data receiving apparatus 302 reads the air-related information out of the related information storage 113 and outputs the information to an external storage 321, in accordance with the download instruction of the user.

As the external storage 321, for example, a memory card may be used. In this case, the memory card is connected to the server accessing apparatus 303. Thus, a related information reader 331 reads the air-related information, and then the server accessor 332 accesses the music delivery server 103. The server accessor 332 receives the air data, and then makes the air data storage 333 store the air data. The reproducer 112 can reproduce the stored air data in accordance with the user's instruction. As the server accessing apparatus 303, for example, a personal computer or the like may be used. In virtue of the above, the construction of the music data receiving apparatus 302 may be simplified so that the cost of the apparatus may be reduced.

(Embodiment 2)

Hereinafter, Embodiment 2 of the present invention will be described.

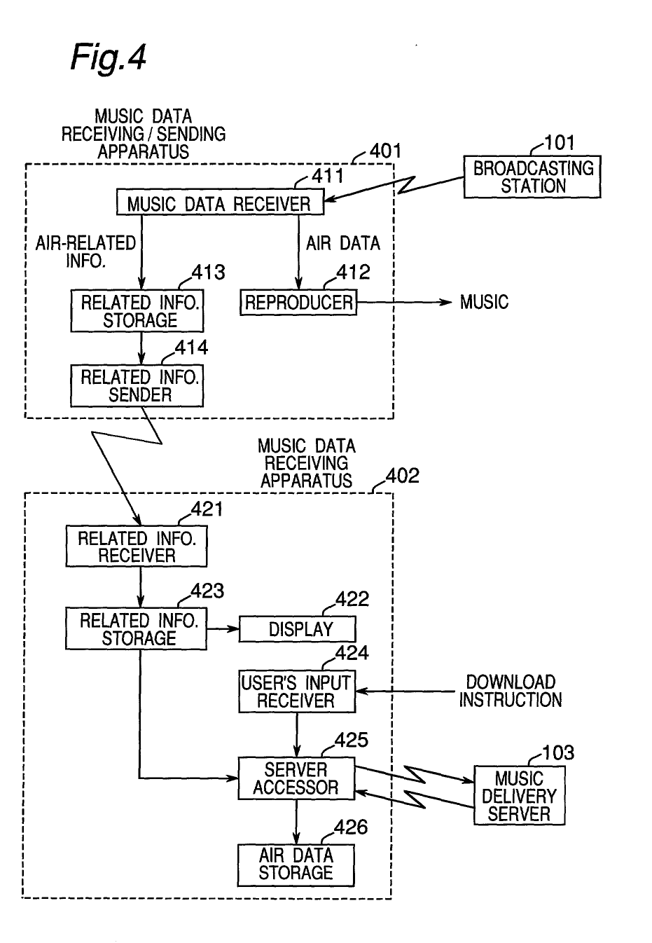

FIG. 4 shows the construction of a system for delivering music (or method of delivering music) according to Embodiment 2 of the present invention.

In FIG. 4, 401 denotes a music data receiving/sending apparatus while 402 denotes a music data receiving apparatus. The apparatus 401 receives music data which have been broadcast by the broadcasting station 101, and then reproduces the music data as music while sending the related information about the reproduced air to the apparatus 402. The apparatus 402 receives the related information relating to the music which has been sent from the music data receiving/sending apparatus 401, and then accesses the music delivery server 103 so as to download the air data, in accordance with the user's instruction.

The music data receiving/sending apparatus 401 includes sections 411 to 414. 411 denotes a music data receiver (music data receiving section) which receives music data which have been broadcast by the broadcasting station 101. 412 denotes a reproducer (reproducing section), which takes out the air information from the music data composed of the air information and the air-related information, and further reproduces the air information as music. 413 denotes a related information storage (related information storing section), which takes out the air-related information from the music data, and further stores the air-related information. 414 denotes a related information sender (related information sending section) which repeatedly sends the related information of the music data stored in the related information storage 413 when the music data is being reproduced.

The music data receiving apparatus 402 includes sections 421 to 426. 421 denotes a related information receiver (related information receiving section), which receives the related information which is being sent by the music data receiving/sending apparatus 401. 423 denotes a related information storage (related information storing section), which stores the related information received by the related information receiver 421. 422 denotes a display (representing section) which represents all of or a part of the contents of the related information. 424 denotes a user's input receiver (user's input receiving section) which receives a user's instruction ordering the apparatus to download the air which is being represented on the display. 425 denotes a server accessor (sever accessing section), which communicates the music delivery server 103, and further downloads the air specified by the air-related information stored in the related information storage 423, in accordance with the download instruction from the user's input receiver 424. 426 denotes an air data storage (air data storing section), which stores the air data downloaded by the server accessor 425.

Hereinafter, with reference to FIG. 4, each of the steps in the method of delivering music according to Embodiment 2 will be described. At first, in the music data receiving/sending apparatus 401, the music data receiver 411 receives the music data which have been broadcast by the broadcasting station 101, and then the reproducer 412 reproduces the music data while the related information storage 413 stores the related information (air-related information) for the music. Further, the related information sender 414 repeatedly sends the related information stored in the related information storage 413 to the outside. The user receives the related information using the music data receiving apparatus 402. The related information is stored in the related information storage 423.

The user can confirm the contents of the received information by referring to the display 422. The user, who is listening to the reproduced music, may give a download instruction, which orders to download the air, to the user's input receiver 424, if the user is pleased with the air. The download instruction is transmitted to the server accessor 425. The server accessor 425 accesses the music delivery server 103. Thus, the server accessor 425 takes out the information for specifying the air to be downloaded from the related information storage 423, and then notifies it to the music delivery server 103. The music delivery server 103 confirms the user's status or charges a fee to the user, and then sends the specified air data. The server accessor 425 receives the air data, and then makes the air data storage 426 store the air data.

The music data receiving/sending apparatus 401 may be disposed, for example, in a store. In the store, the apparatus reproduces the music while sending the related information to the outside. The music data receiving apparatus 402 may be owned by a customer in the store. If the customer is pleased with the air, which is streaming in the store, the user can receive the related information sent from the apparatus 401 in the store, and then can download the air.

As described above, according to Embodiment 2 of the present invention, in the case that the user does not own the apparatus for receiving and reproducing the music also, the user can easily download the air data even if the user does not have any knowledge about the air with which the user is pleased.

Hereupon, the air data storage 426 may be composed of an internal memory of the apparatus or an external storage. Meanwhile, the music data receiving apparatus 402 may be provided with a reproducer so as to be able to reproduce the air data stored in the air data storage 426.

Alternatively, similar to the case of Embodiment 1, the server accessor 425 and the air data storage 426 may be separated from the music data receiving apparatus 402.

Further, a part of the air data may be included in the music-related information sent by the related information sender 414 while the display 422 of the music data receiving apparatus 402 may be constructed such that it has a function to reproduce the part of the air data. In this case, if the related information is held by the related information storage 423 of the music data receiving apparatus 402 after the music data receiving/sending apparatus 401 has finished to reproduce the music, the user will be able to confirm the air when the user will execute the download instruction later. For example, if the user makes the related information storage 423 store some kinds of air-related information at outside, the user can-reproduce a part of the air using the display 422 having the reproducing function after the user comes home, and then can decide whether the user should download the air or not while referring to the reproduced part.

(Embodiment 3)

Hereinafter, Embodiment 3 of the present invention will be described.

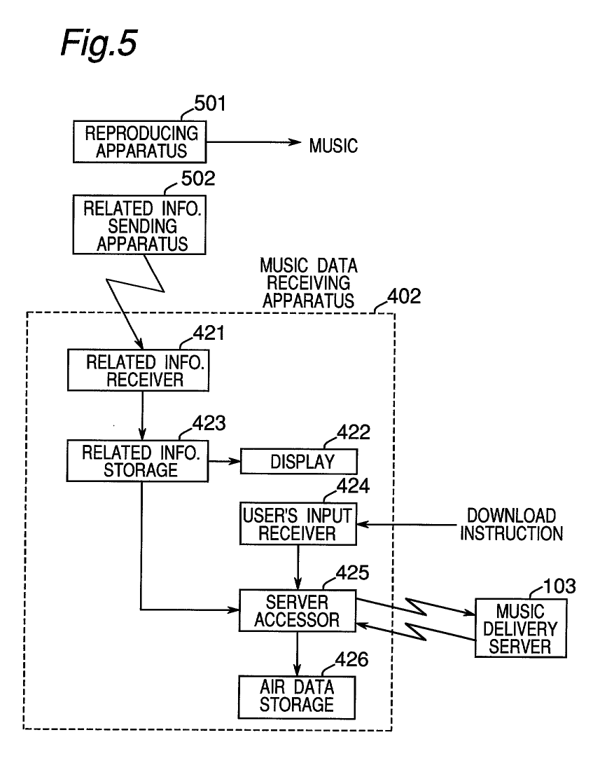

FIG. 5 shows the construction of a system for delivering music (or method of delivering music) according to Embodiment 3 of the present invention.

In FIG. 5, 501 denotes a reproducing apparatus for reproducing music. Hereupon, the concept of the reproducing apparatus 501 includes all of known apparatuses for reproducing music, regardless of whether the music source is broadcast music or package media.

502 denotes a related information sending apparatus, which repeatedly sends the air-related information regarding to the reproduction of the music. The music data receiving apparatus 402 has a specification as same as that of Embodiment 2.

According to the apparatus shown in FIG. 5, for example, if the information related to the music, which is reproduced simultaneously with the movie in a movie theater or the like, is sent in the theater, the audience can easily download the music with which the audience is pleased.

As described above, according to Embodiment 3 of the present invention, a seller, who intends to facilitate a sale of the music, can intentionally send the related information simultaneously with the reproduction of the music so as to stimulate the user to easily download the music.

As described above, according to the present invention, if the music-related information is included in the music data which have been broadcast by the broadcasting station while the related information is separately stored in the receiving apparatus, the user can easily access the music delivery server to download desired air data even if the user does not have any knowledge about the music.

Although the present invention has been fully described in connection with the preferred embodiments thereof with reference to the accompanying drawings, it is to be noted that various changes and modifications are apparent to those skilled in the art. Such changes and modifications are to be understood as included within the scope of the present invention as defined by the appended claims unless they depart therefrom.

What is claimed is:

1. A system for delivering music comprising:
a sending section for sending music data which include air data and air-related information for uniquely specifying the air data.

2. A system for delivering music comprising:
a music delivery server for sending air data in accordance with a delivery demand including air-related information for uniquely specifying the air data, the sent air data being corresponding to the air-related information.

3. The system for delivering music according to claim 1, further comprising a music delivery server for sending the air data corresponding to the air-related information, in accordance with a delivery demand including the air-related information.

4. The system for delivering music according to claim 3, further comprising:
a receiving section for receiving the music data; and
an air data downloading section for sending the delivery demand including the air-related information received by said receiving section to said music delivery server while downloading the air data corresponding to the air-related information which is sent by said music delivery server.

5. The system for delivering music according to claim 3, further comprising:
a receiving section for receiving the music data;
a reproducing section for reproducing the air data received by said receiving section; and
an air data downloading section for sending the delivery demand including the air-related information to said music delivery server in accordance with an instruction of a user who listens to the air data reproduced by said reproducing section, while downloading the air data corresponding to the air-related information which is sent by said music delivery server.

6. The system for delivering music according to claim 1, further comprising:
a reproducing section for reproducing the air data received by said receiving section; and
a music output section for outputting the air-related information in the music data received by said receiving section and all of or a part of the air data as occasion demands, to another apparatus.

7. The system for delivering music according to claim 1, further comprising:
a reproducing section for reproducing the air data received by said receiving section; and
an air data downloading section for downloading the air data corresponding to the air-related information using the air-related information, in accordance with an instruction of a user.

8. An apparatus for receiving music data comprising:
a receiving section for receiving the music data which include all of or a part of air data and air-related information for uniquely specifying the air data;
a reproducing section for reproducing the air data received by said receiving section; and
a downloading section for accessing a music delivery server using the air-related information to download the air data, in accordance with an instruction of a user.

9. The apparatus for receiving music data according to claim 8, further comprising an output section for outputting the air-related information, or all of or a part of the air data.

10. An apparatus for receiving music data comprising:
a receiving section for receiving the music data which include all of or a part of air data and air-related information for uniquely specifying the air data;
a reproducing section for reproducing the air data received by said receiving section; and
an output section for outputting the air-related information, or a part of desired ratio larger than or equal to 0 of the air data.

11. An apparatus for receiving music data comprising:
a receiving section for receiving music data which include a part of desired ratio larger than or equal to 0 of air data and air-related information for uniquely specifying the air data; and
a downloading section for accessing a music delivery server using the air-related information to download the air data, in accordance with an instruction of a user.

12. An apparatus for receiving music data comprising:
a receiving section for receiving music data which include a part of desired ratio larger than or equal to 0 of air data and air-related information for uniquely specifying the air data; and
an output section for outputting the air-related information, or a part of desired ratio larger than or equal to 0 of the air data.

13. An air-related information adding apparatus which receives air data, and then adds air-related information for uniquely specifying the air data.
